(19) United States
(12) Patent Application Publication
(10) Pub. No.: US 2016/0356731 A1
(43) Pub. Date: Dec. 8, 2016

(54) THERMAL CONDUCTIVITY QUARTZ TRANSDUCER WITH WASTE-HEAT MANAGEMENT SYSTEM

(71) Applicant: PROBE HOLDINGS, INC., Houston, TX (US)

(72) Inventors: Øivind GODAGER, Sandefjord (NO); Mike SERRANO, Bellflower, CA (US); Ralph Theron NELMS, Highlands Ranch, CO (US)

(21) Appl. No.: 14/732,341

(22) Filed: Jun. 5, 2015

(51) Int. Cl. G01N 25/18; G01K 7/32

(52) U.S. Cl. CPC G01N 25/18; G01K 7/32

(57) ABSTRACT

Thermal conductivity quartz transducer with waste-heat management system comprising: a first quartz resonator configured to provide a first temperature signal representing an ambient temperature of said thermal conductivity quartz transducer, a heat dissipation element a second quartz resonator configured for providing a second temperature signal representing a dissipation temperature of said heat dissipation element an electronics circuit, heat guiding means arranged for transferring a heat generated by said electronics circuit to said heat dissipation element, so that said dissipation temperature is higher than said ambient temperature.

### FIELD OF THE INVENTION

The present invention relates to the technical field of thermal conductivity sensors. More specifically the invention relates to a quartz pressure/temperature transducer with a waste-heat management system for gauging thermal conductivity.

### BACKGROUND OF THE INVENTION

### Description of the Related Art

Convection, or convective heat transfer, occurs when fluids in motion transfers heat from one place to another. Convection can be both the result of a controlled process, or a means for obtaining a result in a process. In any case, convection, and changes in convection can be important to understand both the process itself and the result of the process.

One example is convection in a wellbore. Convection changes may indicate permeability changes, fluid type changes, thermic changes etc. Since water has a higher thermic conductivity than oil, convection changes may indicate more or less water with regard to the oil.

A thermal anemometer uses a thermic detector to detect the cooling of the fluid passing by the thermic detector to obtain the fluid speed.

The Hot-Wire Anemometer is the most well-known thermal anemometer, and measures a fluid velocity by noting the heat convected away by the fluid. The core of the anemometer is an exposed hot wire, either heated up by a constant current or maintained at a constant temperature. In either case, the heat lost to fluid by convection is a function of the fluid velocity.

By measuring the change in wire temperature under constant current or the current required to maintain a constant wire temperature, the heat lost can be obtained. The heat lost can then be converted into a fluid velocity in accordance with convective theory. Typically, the anemometer wire is made of platinum or tungsten and is 4˜10 μm (158˜393 μin) in diameter and 1 mm (0.04 in) in length.

Due to the tiny size of the wire, it is fragile and thus suitable only for clean gas flows. In liquid flow or rugged gas flow, a platinum hot-film coated on a 25˜150 mm (1˜6 in) diameter quartz fiber or hollow glass tube can be used instead.

Another alternative is a pyrex glass wedge coated with a thin platinum hot-film at the edge tip. However thermal anemometers require in general electric power to function. In some remote applications power is not always available and the sensors have to operate with batteries or power harvesting. It is therefore a need to develop thermal conductivity sensors where the requirement for external power is reduced, and where the sensors can be used in harsh environments.

### SUMMARY OF THE INVENTION

The invention is a thermal conductivity sensor configured to be arranged in a fluid comprising:
a first quartz resonator configured to provide a first temperature signal representing an ambient temperature of said thermal conductivity sensor configured for being in thermal connection with said fluid configured for providing a second temperature signal representing a dissipation temperature of said heat dissipation element arranged for transferring a heat generated by said electronics circuit to said heat dissipation element is higher than said ambient temperature.

As discussed previously, quartz resonators have a number of beneficial characteristics that can be exploited within the field of sensor technology. Although they have low power requirements, such sensors are dependent on a driver circuit and other electronic circuits to function. These circuits may be powered from a local battery, a power line or by wireless power, i.e. power harvesting from an electromagnetic field.

In a number of applications where power harvesting is used to power the electronics, the efficiency of the wireless power transfer is low, and increasing the transmitted power is not always possible or desirable. The current invention solves this problem by reducing the power requirements on the sensor side by convecting already available superfluous heat from the electronics circuit to a heat dissipation element. Therefore, no additional power is required to detect heat loss from the heat dissipation element.

The thermal conductivity sensor may be integrated with other sensors, such as e.g. pressure sensors and use superfluous heat from electronics circuits in relation to these sensors to pre-heat the dissipation element.

### BRIEF DESCRIPTION OF THE DRAWINGS

The attached figures illustrate some embodiments of the claimed invention.

FIG. 1 illustrates an embodiment of the thermal conductivity quartz transducer (1).

FIG. 2 illustrates a further embodiment of the thermal conductivity quartz transducer (1), where it is integrated with a quartz based pressure sensor.

FIG. 3 illustrates the principle used for detection of the thermal conductivity of fluids according to the invention.

### DETAILED DESCRIPTION

The invention will in the following be described and embodiments of the invention will be explained with reference to the accompanying drawings.

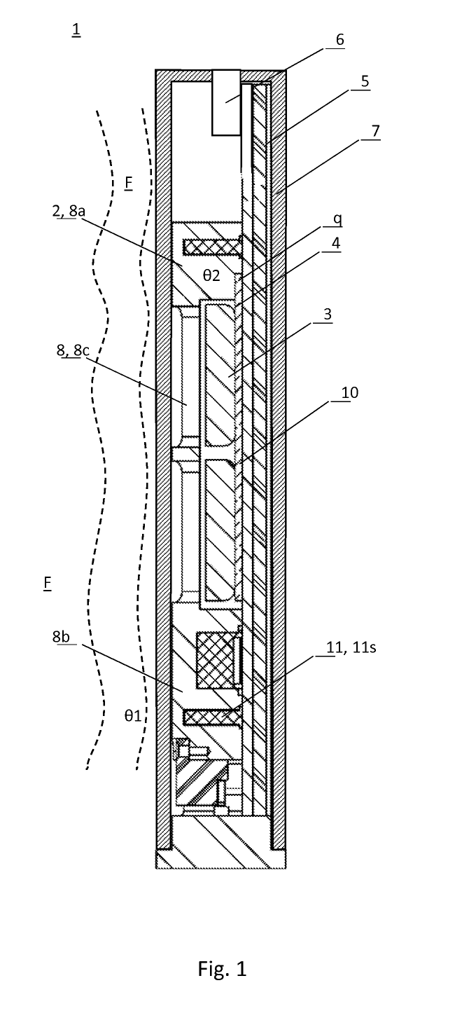

FIG. 1 illustrates an embodiment of a thermal conductivity quartz transducer (1) according to the invention. The stapled lines indicate a fluid (F) along the sensor. The fluid may be mixed with different types of solid materials.

In this embodiment the thermal conductivity quartz transducer (1) comprises a first quartz resonator (11) configured to provide a first temperature signal (11s) representing an ambient temperature (81) of said thermal conductivity quartz transducer (1). The first quartz resonator (11) is therefore in thermal connection with the fluid (F) outside the transducer (1), and a change in ambient temperature (θ1), i.e. the temperature for the fluid (F), will be detected by the first quartz resonator (11).

Further, the thermal conductivity quartz transducer (1) comprises a heat dissipation element (2) configured for being in thermal connection with the fluid (F) and a second quartz resonator (21) configured for providing a second temperature signal (21s) representing a dissipation temperature (82) of said heat dissipation element (2).

The thermal conductivity quartz transducer (1) also comprises one or more electronics circuits (3), and heat guiding means (4) arranged for transferring a heat (q) generated by the electronics circuit (3) to the heat dissipation element (2), so that the dissipation temperature (82) is higher than the ambient temperature (θ1).

It should be noted that the dissipation temperature (θ2) represents a temperature of the heat dissipation element (2) and not the fluid temperature. However the fluid temperature will affect the dissipation temperature (θ2) as described below.

In this embodiment the two temperature sensors used are quartz resonators. Quartz resonators have a high accuracy, and are able to detect small temperature changes. The resonators require driver circuits that has to be powered with electric energy.

However, for a number of applications, such as e.g. when used as a logging tool in a wellbore, the power available is often limited. E.g. if the sensor is battery operated, or powered by power harvesting of a wireless link, higher power requirements would mean shorter battery life or a wireless link with less performance. According to the invention, heat from the electronics circuit (3) that is necessary for operating the resonators is used directly to heat up the heat dissipation element (2). This heat is in background art treated as excess heat that is deflected out of the transducer and represents a waste of energy.

According to an embodiment, the electronics circuit (3) generating heat therefore comprises a driver circuit for said first and second quartz resonators (11, 21).

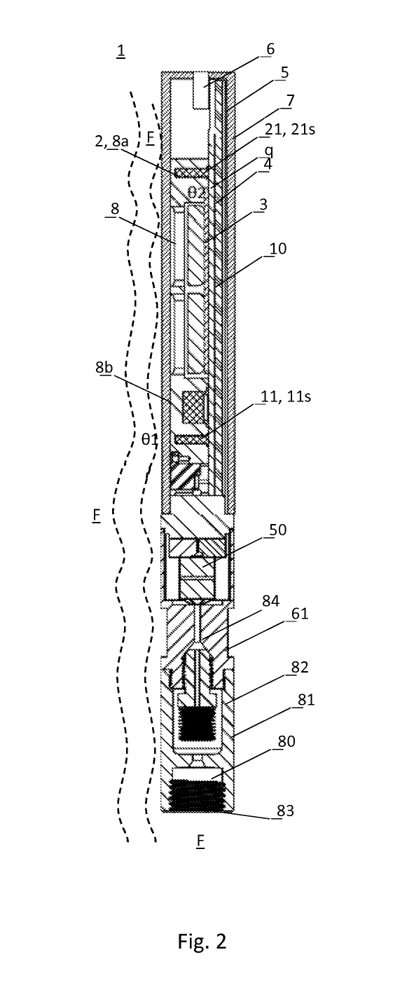

FIGS. 2 illustrates another embodiments of a thermal conductivity quartz transducer (1), which in principle is the same as the transducer illustrated in FIG. 1, but it comprises in addition an integrated pressure sensor as will be explained below.

In an embodiment the electronics circuit (3) is arranged for generating a constant heat (q) over time. In this way the heat (q) reaching the heat dissipation element (2) via the heat guiding means (4) will also be constant. It will therefore be possible to determine changes in the fluid type and/or fluid velocity as will be described later.

According to an embodiment the quartz resonators of are thickness shear mode resonators (TSMR). TSMR resonators consists of a plate (often circular) of crystalline quartz with thin-film metal electrodes deposited on the faces. The inverse piezoelectric effect is used to produce vibration in response to alternating voltages. For a thickness shear mode resonator, the crystallographic orientation of the disc is selected so that an electric potential applied through the thickness of the disc produces a shear stress.

The dimensions, density, and stiffness of the quartz resonator determine the resonant frequency of vibration. Vibration can be driven at low power because of the low mechanical losses within the material. The resonator, which is often circular, can be supported at the circumference, since the vibration is concentrated in the center.

The resonance frequency of oscillation of the current in a circuit in which the quartz crystal is mounted will change as the temperature of the quartz crystal changes.

The invention makes use of a temperature difference taking place over the transducer, where the difference will vary with external convection. In general the following expression is valid for a system.

Input energy flow−output energy flow+heat supplied−work done=Rate of change of thermic energy.

Thermal resistance R can be defined as:

$$R = \frac{Δ θ}{q}$$

Where Δθ is the temperature difference and q is the heat transfer. In the time domain we get the following expression for the temperature difference:

Δθ(t)=R·q(t)

R can comprise contributions from conduction, convection and radiation. The heat capacity is given as:

C=m·c

Where m is the mass of the body and c is the specific heat capacity of a material on a per mass basis.

Coulombs law gives us:

$$Δ θ ( t ) = \frac{1}{C} {\int }_{0}^{t} q ( t ) d t$$

### Or

$$q ( t ) = C \cdot \frac{d Δ θ}{d t}$$

In the following, the ambient temperature is denoted (θ1), and the inner temperature denoted (θ2). The inner temperature is affected by the heat supplied and dissipated. In general:

θ₁<θ₂

The following equation describes the energy balance for the transducer or sensor arranged in a fluid environment:

$${q}_{inn} ( t ) - {q}_{at} ( t ) = C \cdot \frac{d {θ}_{2}}{d t}$$

$${q}_{inn} ( t ) = \frac{1}{R} ( ( {θ}_{2} ( t ) - {θ}_{1} ( t ) )$$

Where:

$$R = \frac{1}{h \cdot A}$$

A is the cross section of the sensor, h is the convection heat transfer coefficient and;

qᵢₙₙ(t)

Is the supplied heat.

The following equation follows from the above:

$$T \frac{d Δ {θ}_{2}}{d t} = ( {θ}_{2} ( t ) - {θ}_{1} ( t )$$

Where we have introduced the time constant of the sensor:

T=R·C

T increases when the mass increases and decreases with increasing thermal conductivity, 1/R.

In other words, T will reflect how fast the system reacts to a change in the thermal conductivity, 1/R for the fluid adjacent the sensor.

Different fluids have different heat capacity, which again depends on the heat transfer coefficient h. Further, if the fluid is in motion, the heat capacity will increase, which again will influence the thermal energy balance in the transducer or sensor.

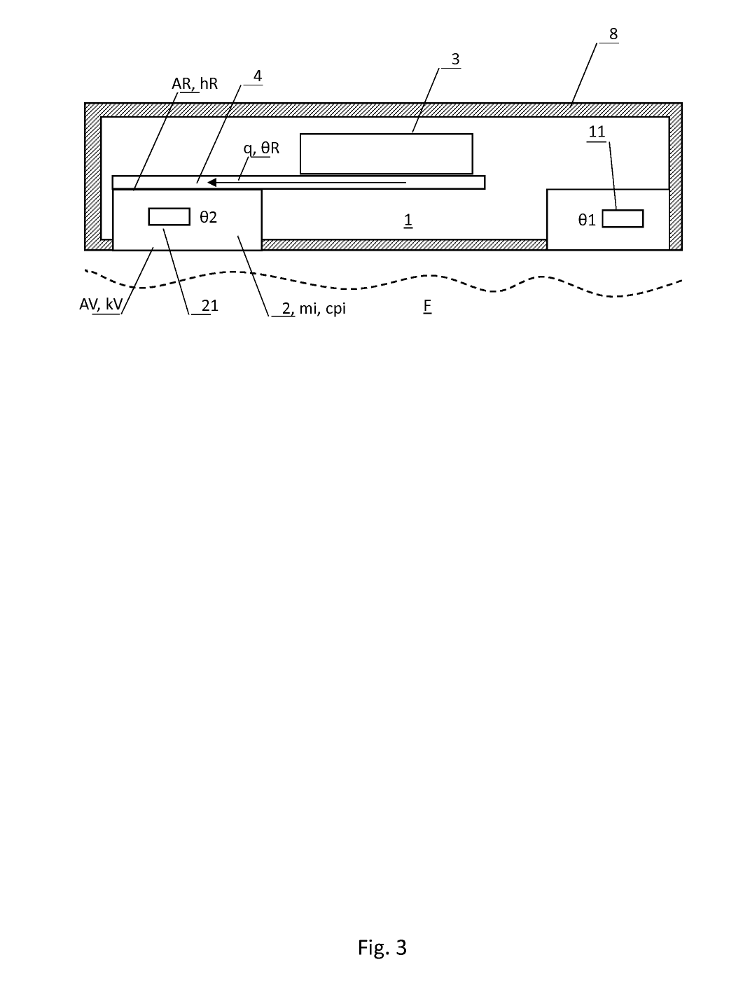

The theory applied to determine changes in fluid type or composition, as well as fluid flow in the invention will now be explained in more detail with reference to FIG. 3. According to the invention, two temperature sensors are used, The first temperature sensor (11) senses the ambient temperature (θ1), and the second temperature sensor (21) senses the inner temperature (θ2) affected by the heat supplied in the transducer and the heat dissipated to the surrounding fluids. According to the invention the supplied heat (q) is generated by an electronics circuit (3) and guided by heat guiding means (4), as indicated by the arrow, to the heat dissipation element (2) and from there out into the surrounding fluids. The second temperature sensor (21) is arranged adjacent the heat dissipation element (2) and will therefore sense an inner temperature (θ2) higher than the ambient temperature (θ1) sensed by the first quartz resonator (11) due to the supplied heat (q).

In the following the energy balance of the system (1) according to the invention be derived, where the following definitions are used:

mi: mass of the heat dissipation element (2)
c_{Pi}: heat capacity of the heat dissipation element (2)
A_{R}: the effective cross section of the heat dissipation element (2) that the heat (q) from the heat dissipation element (2) is dissipated towards.
A_{V}: effective cross section of the heat dissipation element (2) that dissipates heat towards the adjacent fluid.
h_{R}: heat transfer coefficient of the heat guiding means (4) where the heat guiding means (4) interfaces the heat dissipation element (2).
k_{V}: heat transfer coefficient for the heat dissipation element (2) where the heat dissipation element (2) interfaces the surrounding fluid.
θR: Temperature in heat guiding means (4).
θu=θ1: Ambient temperature in surrounding fluids.
θi=θ2: Temperature sensed by the second quartz resonator (21)

The energy balance of the transducer is:

Supplied energy=Accumulated energy+Dissipated energy, where

Supplied energy is:

A_{R}·h_{R}·(θ_{R}−θᵢ)

Dissipated energy is:

A_{V}·k_{V}·(θᵢ−θᵤ)

And accumulated energy is:

$${m}_{i} \cdot {c}_{{P}_{i}} \cdot \frac{d {θ}_{i}}{d t}$$

$${m}_{i} {c}_{{P}_{i }} ( \frac{d}{d t} {θ}_{i} ( t ) )$$

The total energy balance expressed by the temperature accumulation can be expressed as:

$${m}_{i} \cdot {c}_{{P}_{i}} \cdot \frac{d {θ}_{i}}{d t} = {A}_{R} \cdot {h}_{R} \cdot ( {θ}_{R} - {θ}_{i} ) - {A}_{V} \cdot {K}_{V} \cdot ( {θ}_{i} - {θ}_{u} )$$

$${m}_{i} {c}_{{P}_{i}} ( \frac{d}{d t} {θ}_{i} ( t ) ) = {A}_{R} {h}_{R} ( {θ}_{R} - {θ}_{i} ( t ) ) - {A}_{V} {k}_{V} ( {θ}_{i} ( t ) - {θ}_{u} )$$

$$\frac{d {θ}_{i}}{d t} = \frac{{A}_{R} \cdot {h}_{R}}{{m}_{i} \cdot {c}_{{P}_{i}}} \cdot ( {θ}_{R} - {θ}_{i} ) - \frac{{A}_{V} \cdot {k}_{V}}{{m}_{i} \cdot {c}_{{P}_{i}}} \cdot ( {θ}_{i} - {θ}_{u} )$$

$$\frac{d}{d t} {θ}_{i} ( t ) = \frac{{A}_{R} {h}_{R} ( {θ}_{R} - {θ}_{i} ( t ) )}{{m}_{i} {c}_{{P}_{i }}} - \frac{{A}_{V} {k}_{V} ( {θ}_{i} ( t ) - {θ}_{u} )}{{m}_{i} {c}_{{P}_{i}}}$$

In the case where the electronic circuits generates a constant amount of heat, the only unknown in the transfer function is the heat transfer coefficient (kV) on the interface between the heat dissipation element (2) and the fluid. The heat transfer coefficient (kV) will vary with the properties of the surrounding fluid, and the fluids ability to absorb heat.

The heat transfer coefficient (kV) will therefore vary with heat capacity and thermal conductivity. I.e., if the fluid has a low thermal conductivity the inner temperature (θ2) will increase and the difference between the inner temperature (θ2) and the ambient temperature (θ1) will increase.

If the surrounding fluids have a high thermal conductivity, the temperature difference will decrease and eventually stabilize at a lower level. The same will happen if the transducer is under the influence of a fluid flow, since the flowing fluid has a higher heat dissipation due to a higher heat capacity, i.e. the amount of fluid per time unit increases.

The first and second quartz resonators (11, 21) will have corresponding first and second temperature signals (11s, 21s). These signals will typically be available through a connector (not shown) in the transducer device housing (7). The signals may also be pre-processed, or coded in an electronic circuit before leaving the housing (7). The electronic circuit responsible for signal communication may in an embodiment be arranged in thermal connection with the heat guiding means (4), so that heat dissipated from the circuit can be used to pre-heat the heat dissipation element (2).

Typically the electronic circuits and components of the thermal conductivity quartz transducer (1) are placed on one or more circuit boards (10) as seen in FIG. 1, but they may also be interconnected by wires or shielded cables, such as coaxial cables.

FIG. 2 illustrates an advantageous embodiment of the invention, where the thermal conductivity quartz transducer (1) comprises a third sensor, preferably a quartz resonator with a driver circuit that is thermally connected to the heat guiding means (4), so the that the heat, that would normally be wasted for a comparable transducer according to prior art, can be utilized in the thermal conductivity transducer according to the invention.

The third sensor, including the embodiments described below, can be used in combination with all embodiments described above for the thermal conductivity quartz transducer (1).

The additional sensor, or transducer (61), can in an embodiment be a multi-chambered pressure sensor, comprising:

a first oil filled chamber (80);

a pressure transfer means (84) between the first oil filled chamber (80) and the pressure sensor (50), arranged to isolate the pressure sensor (50) from the oil filled chamber (80); and
a pressure permeable filter port (83) through the housing (81) to allow pressure from outside the housing (81) to act on the first oil filled chamber (80).

Thus, the pressure inside the first oil filled chamber (80) will be the same as the pressure outside the housing (81) since a pressure connection has been established through the filter port (83). In this way the internal fluid inside the housing (81) can be hydraulically balanced with pressure outside the pressure sensor even through a layer of cement by relying on hydraulic connectivity.

The pressure transfer means (84) transfers the pressure of the first filled oil chamber (80) to the pressure sensor (50). In an embodiment the pressure transfer means (84) comprises a second oil filled chamber (82).

The permeable filter port (83) is the hydraulic gateway connecting first oil filled chamber (80) to the surrounding formation and automatically equalizes any pressure difference between sensor filter port (83) and the exterior formation pressure.

In an embodiment the filter port (83) is one or more slits through the housing (81).

The filter port (83) is preferably filled with pressure permeable material saturated by a buffer fluid, typically a filling of viscous oil, which provides an excellent pressure transfer fluid to the port surroundings.

Moreover, an additional feature of the filter port (83) when the pressure permeable material is wet and saturated by the oil fill from the first oil filled chamber (80), is that it in turn avoids clogging as it prevents the wellbore grouting cement to bind to the pressure permeable material. In an embodiment the pressure permeable material extends from the filter port (83) outside the housing (81), and increases the filter volume. This feature grants the hydraulic connectivity of the sensor to its surroundings.

In an embodiment the pressure permeable material is hemp fiber, and the slit of the filter port (83) is filled with the hemp fiber.

In an alternative embodiment the pressure permeable material consists of a number of pressure permeable capillary tubes extending radially outwards from the slit.

The sensor (50) is in an embodiment connected electrically to an electronics circuit (3) of the system.

1. A thermal conductivity quartz transducer configured to be arranged in a fluid comprising:
a first quartz resonator configured to provide a first temperature signal representing an ambient temperature of said thermal conductivity quartz transducer;
a heat dissipation element configured for being in thermal connection with said fluid;
a second quartz resonator configured for providing a second temperature signal representing a dissipation temperature of said heat dissipation element;
an electronics circuit; and
heat guiding means arranged for transferring a heat generated by said electronics circuit to said heat dissipation element, so that said dissipation temperature is higher than said ambient temperature.

2. The thermal conductivity quartz transducer according to claim 1, wherein said electronics circuit is arranged for generating said heat as a constant heat over time.

3. The thermal conductivity quartz transducer according to claim 1, wherein said electronics circuit comprises driver circuits for said first and second quartz resonators, wherein said driver circuits are arranged to dissipate waste heat to said heat guiding means.

4. The thermal conductivity quartz transducer according to claim 1, wherein said electronics circuit comprises a metallic housing in thermal contact with said heat guiding means.

5. The thermal conductivity quartz transducer according to claim 1, comprising a chassis comprising first and second end blocks, wherein said first end block is said dissipation element and said second end block is housing said first quartz resonator , wherein said first and second end blocks are interconnected by a middle section with a smaller cross section than said first and second end blocks.

5. The thermal conductivity quartz transducer according to claim 2, wherein said chassis is made of Inconel.

6. The thermal conductivity quartz transducer according to claim 1, comprising a cylindrical housing about said chassis.

7. The thermal conductivity quartz transducer according to claim 1, wherein said first quartz resonator is arranged to resonate in thickness shear mode.

8. The thermal conductivity quartz transducer according to claim 6, wherein said first quartz resonator is AT, BT, AC or Y-cut.

9. The thermal conductivity quartz transducer according to claim 1, comprising a third quartz resonator with a driver circuit that is thermally connected to said heat guiding means and arranged to dissipate waste heat to said heat guiding means.

10. The thermal conductivity quartz transducer according to claim 9, comprising a pressure sensor, wherein said third quartz resonator is configured to sense pressure changes in said fluid.
